(19) United States
(12) Patent Application Publication
(10) Pub. No.: US 2013/0271391 A1
(43) Pub. Date: Oct. 17, 2013

(54) Electronic Paper Touch Apparatus

(71) Applicants: Yen-Hung Tu, Taipei (TW); Chung-Lin Chia, Taipei (TW)

(72) Inventors: Yen-Hung Tu, Taipei (TW); Chung-Lin Chia, Taipei (TW)

(73) Assignee: Rich IP Technology Inc., Taipei (TW)

(21) Appl. No.: 13/615,258

(22) Filed: Sep. 13, 2012

(30) Foreign Application Priority Data
Apr. 12, 2012 (TW) 101113006

(51) Int. Cl. G06F 3/041

(52) U.S. Cl. 345/173

(57) ABSTRACT

An electronic paper touch apparatus, including: a first electrode layer; an electronic paper display layer, located above the first electrode layer; a transparent electrode layer, located above the electronic paper display layer; and a control unit, having a touch mode and an electronic paper mode, wherein when in the touch mode, the control unit will have a touch voltage source coupled between the first electrode layer and the transparent electrode layer to execute a capacitive touch detection procedure; when in the electronic paper mode, the control unit will have an electronic paper voltage source coupled between the first electrode layer and the transparent electrode layer to execute an electronic paper image update procedure.

### BACKGROUND OF THE INVENTION

1. Field of the Invention

The present invention relates to a touch apparatus, especially to an electronic paper touch apparatus, which is capable of multiplexing an electronic paper structure to execute an electronic paper image update procedure or a capacitive touch detection procedure.

2. Description of the Related Art

General button type touch apparatuses use mechanical buttons or resistive buttons as touch input means, and the top surfaces of the mechanical buttons or resistive buttons are generally attached or printed with symbols or figures for function indications.

However, the mechanical buttons or resistive buttons have the disadvantage of getting worn out easily. Besides, as the symbols or figures are generally fixed, a user cannot be sure whether it is working or not when he/she pushes the mechanical buttons or resistive buttons.

To solve the foregoing problems, a novel, endurable, and touch-responsive touch apparatus is therefore needed.

### SUMMARY OF THE INVENTION

One objective of the present invention is to disclose an electronic paper touch apparatus, which can make use of a bi-stable display characteristic of electronic paper to provide display function and touch function simultaneously.

Another objective of the present invention is to disclose an electronic paper touch apparatus, which can utilize an electrode layer of an electronic paper device to execute an electronic paper image update procedure or a capacitive touch detection procedure.

Another objective of the present invention is to disclose an electronic paper touch apparatus, which can utilize two electrode layers of an electronic paper device to execute an electronic paper image update procedure or a capacitive touch detection procedure.

Another objective of the present invention is to disclose an electronic paper touch apparatus, which can offer two capacitive touch planes on two opposite sides of an electronic paper device.

Still another objective of the present invention is to disclose an electronic paper touch apparatus, which can alter a static touch figure in response to a touch input to facilitate a user in performing a touch operation.

To attain the foregoing objectives, an electronic paper touch apparatus is proposed, including:

a first electrode layer, having multiple strip electrodes extending along a first direction;

an electronic paper display layer, located above the first electrode layer;

a transparent electrode layer, located above the electronic paper display layer and having multiple transparent strip electrodes extending along a second direction, the second direction being perpendicular or skew to the first direction; and

a control unit, having a touch mode and an electronic paper mode, wherein when in the touch mode, the control unit will have a touch voltage source coupled between the first electrode layer and the transparent electrode layer to execute a capacitive touch detection procedure; when in the electronic paper mode, the control unit will have an electronic paper voltage source coupled between the first electrode layer and the transparent electrode layer to execute an electronic paper image update procedure.

In the apparatus, the electronic paper display layer includes multiple micro capsules, multiple micro cups, or multiple rotatable balls.

Preferably, the voltage of the touch voltage source is not higher than the voltage of the electronic paper voltage source.

Preferably, the first electrode layer includes a transparent material.

Preferably, the electronic paper touch apparatus further includes a protective glass layer covering the transparent electrode layer.

To attain the foregoing objectives, another electronic paper touch apparatus is proposed, including:

a first electrode layer, having multiple electrodes;

an electronic paper display layer, located above the first electrode layer;

a transparent electrode layer, located above the electronic paper display layer and being a planar transparent electrode; and

a control unit, having a touch mode and an electronic paper mode, wherein when in the touch mode, the control unit will output multiple touch voltages to multiple corners of the transparent electrode to execute a capacitive touch detection procedure; when in the electronic paper mode, the control unit will have an electronic paper voltage source coupled between the first electrode layer and the transparent electrode layer to execute an electronic paper image update procedure.

In the apparatus, the electronic paper display layer includes multiple micro capsules, multiple micro cups, or multiple rotatable balls.

Preferably, the multiple touch voltages are not higher than the voltage of the electronic paper voltage source.

Preferably, the first electrode layer is located above a substrate.

Preferably, the electronic paper touch apparatus further includes a protective glass layer covering the transparent electrode layer.

To attain the foregoing objectives, still another electronic paper touch apparatus is proposed, including:

a first electrode layer;

an electronic paper display layer, located above the first electrode layer;

a first transparent electrode layer, located above the electronic paper display layer;

a transparent dielectric layer, located above the first transparent electrode layer;

a second transparent electrode layer, located above the transparent dielectric layer; and

a control unit, having a touch mode and an electronic paper mode, wherein when in the touch mode, the control unit will have a touch voltage source coupled between the first transparent electrode layer and the second transparent electrode layer to execute a capacitive touch detection procedure; when in the electronic paper mode, the control unit will have an electronic paper voltage source coupled between the first electrode layer and the first transparent electrode layer to execute an electronic paper image update procedure.

In the apparatus, the electronic paper display layer includes multiple micro capsules, multiple micro cups, or multiple rotatable balls.

Preferably, the voltage of the touch voltage source is not higher than the voltage of the electronic paper voltage source.

Preferably, the first electrode layer is located above a substrate.

Preferably, the electronic paper touch apparatus further includes a protective glass layer covering the second transparent electrode layer.

In one embodiment, the first electrode layer includes multiple first strip electrodes extending along a first direction; the first transparent electrode layer includes multiple first transparent strip electrodes extending along a second direction, the second direction being perpendicular or skew to the first direction; and the second transparent electrode layer includes multiple second transparent strip electrodes extending along a third direction, the third direction being perpendicular or skew to the second direction.

In another embodiment, the first electrode layer has multiple electrodes; the first transparent electrode layer is a planar transparent electrode; and the second transparent electrode layer has multiple transparent electrodes.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1(a)-1(b) illustrate an electronic paper touch apparatus according to a preferred embodiment of the present invention.

FIG. 1(c)-1(e) illustrate the structures of the micro capsules, micro cups, and rotatable balls.

FIG. 2(a)-2(b) illustrate an electronic paper touch apparatus according to another preferred embodiment of the present invention.

FIG. 3(a)-3(b) illustrate an electronic paper touch apparatus according to another preferred embodiment of the present invention.

FIG. 4(a)-4(b) illustrate an electronic paper touch apparatus according to still another preferred embodiment of the present invention.

### DETAILED DESCRIPTION OF THE PREFERRED EMBODIMENTS

The present invention will be described in more detail hereinafter with reference to the accompanying drawings that show the preferred embodiments of the invention.

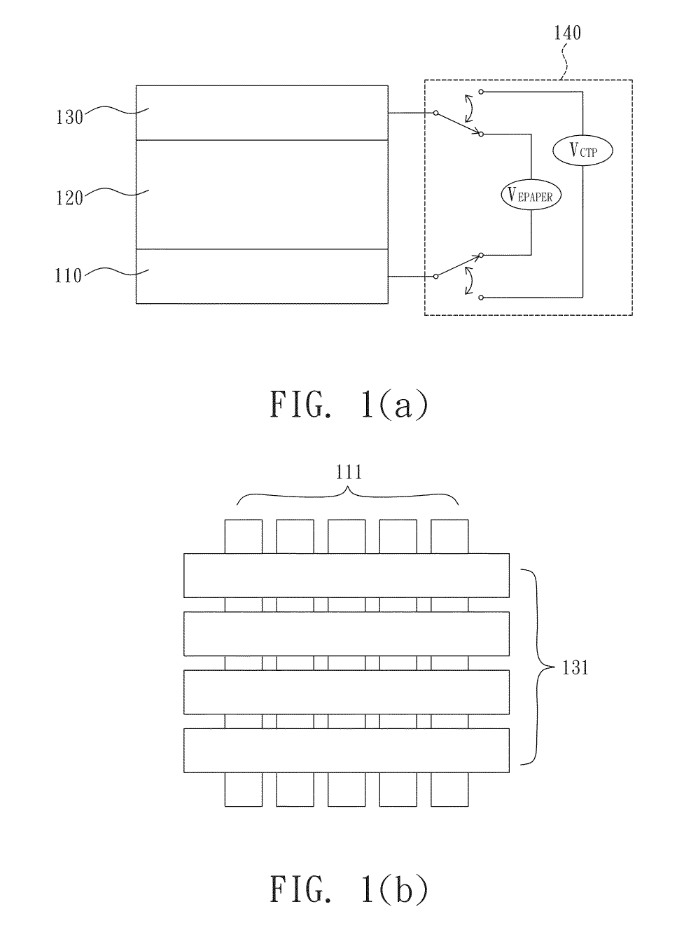

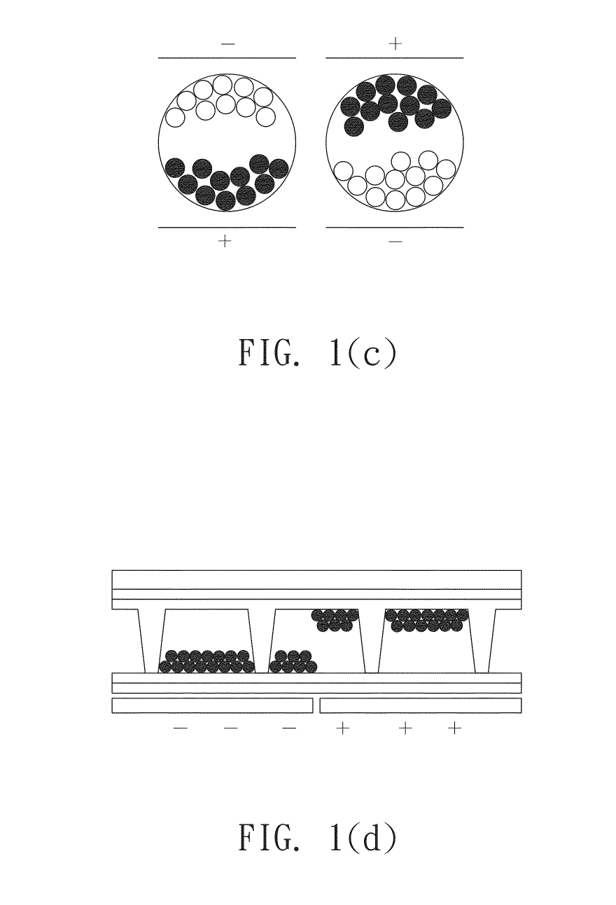

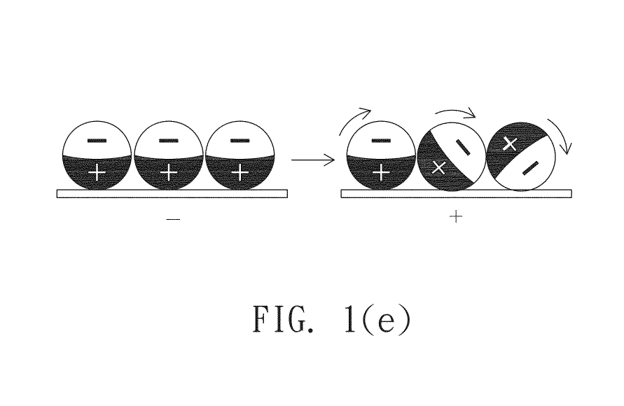

Please refer to FIG. 1(a)-1(b), which illustrate an electronic paper touch apparatus according to a preferred embodiment of the present invention. As illustrated in FIG. 1(a), the electronic paper touch apparatus has a first electrode layer 110, an electronic paper display layer 120, a transparent electrode layer 130, and a control unit 140.

As illustrated in FIG. 1(b), the first electrode layer 110 has multiple strip electrodes 111 extending along a first direction.

The electronic paper display layer 120, located above the first electrode layer 110, can be a display layer having multiple micro capsules, a display layer having multiple micro cups, or a display layer having multiple rotatable balls. The structures of the micro capsules, micro cups, and rotatable balls are illustrated in FIG. 1(c)-1(e).

The transparent electrode layer 130, for example but not limited to a transparent ITO (Indium Tin Oxide) layer, is located above the electronic paper display layer 120 and has multiple transparent strip electrodes 131 extending along a second direction. The second direction is perpendicular or skew to the first direction.

The control unit 140 has a touch mode and an electronic paper mode, wherein, when in the touch mode, the control unit 140 will have a touch voltage source V_{CTP} coupled between the first electrode layer 110 and the transparent electrode layer 130 to execute a capacitive touch detection procedure, so as to detect a touch operation; when in the electronic paper mode, the control unit 140 will have an electronic paper voltage source V_{EPAPER} coupled between the first electrode layer 110 and the transparent electrode layer 130 to execute an electronic paper image update procedure, so as to provide a display. As the capacitive touch detection procedure (including a charging step, a charge redistribution step, and a comparison step) and the electronic paper image update procedure are known prior arts, therefore, they will not be addressed further.

The touch voltage source V_{CTP} has a first voltage, and the electronic paper voltage source V_{EPAPER} has a second voltage. Preferably, the first voltage is not higher than the second voltage.

Preferably, the capacitive touch detection procedure further includes a reverse bias step—executed after the comparison step—to compensate the impact on the electronic paper display layer 120 caused by the charging step. For example, when +5V is used in the charging step to couple between the first electrode layer 110 and the transparent electrode layer 130, a −5V can be used in the reverse bias step to couple between the first electrode layer 110 and the transparent electrode layer 130.

Preferably, the first electrode layer 110 is made of a transparent material, for example but not limited to ITO, so as to provide two capacitive touch planes on two opposite sides of the electronic paper display layer 120. The image a user sees on the electronic paper display layer 120 when the user performs a touch operation on the first electrode layer 110 will be complementary to the image the user sees on the electronic paper display layer 120 when the user performs a touch operation on the transparent electrode layer 130. That is, if the user sees an image of light text on dark background when touching the first electrode layer 110, the user will see an image of dark text on light background when touching the transparent electrode layer 130.

Preferably, the electronic paper touch apparatus further has a protective glass layer (not shown in the figure) covering the transparent electrode layer 130.

As a result, a touch symbol or figure can change in response to touch input to facilitate a user to perform a touch operation. For example, bar-lines can be altered in response to a volume touch operation, to inform a user of the status of the volume touch operation.

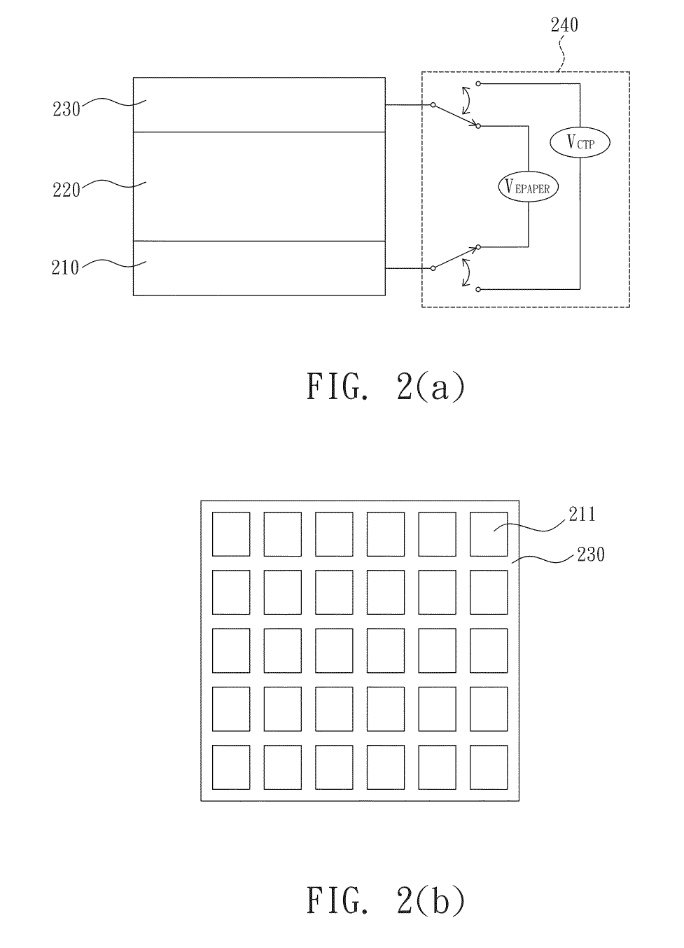

Please refer to FIG. 2(a)-2(b), which illustrate an electronic paper touch apparatus according to another preferred embodiment of the present invention. As illustrated in FIG. 2(a), the electronic paper touch apparatus includes a first electrode layer 210, an electronic paper display layer 220, a transparent electrode layer 230, and a control unit 240.

As illustrated in FIG. 2(b), the first electrode layer 210 has multiple electrodes 211.

The electronic paper display layer 220, located above the first electrode layer 210, can be a display layer having multiple micro capsules, a display layer having multiple micro cups, or a display layer having multiple rotatable balls.

The transparent electrode layer 230, for example but not limited to a transparent ITO layer, is located above the electronic paper display layer 220 and is a planar transparent electrode.

The control unit 240 has a touch mode and an electronic paper mode, wherein, when in the touch mode, the control unit 240 will output multiple touch voltages to multiple corners of the transparent electrode layer 230 to execute a capacitive touch detection procedure, so as to detect a touch operation; when in the electronic paper mode, the control unit 240 will have an electronic paper voltage source V_{EPAPER} coupled between the first electrode layer 210 and the transparent electrode layer 230 to execute an electronic paper image update procedure, so as to provide a display.

Preferably, the multiple touch voltages are not higher than a voltage of the electronic paper voltage source V_{EPAPER}.

Preferably, the first electrode layer 210 is located above a substrate (not shown in the figure).

Preferably, the electronic paper touch apparatus further includes a protective glass layer (not shown in the figure) covering the transparent electrode layer 230.

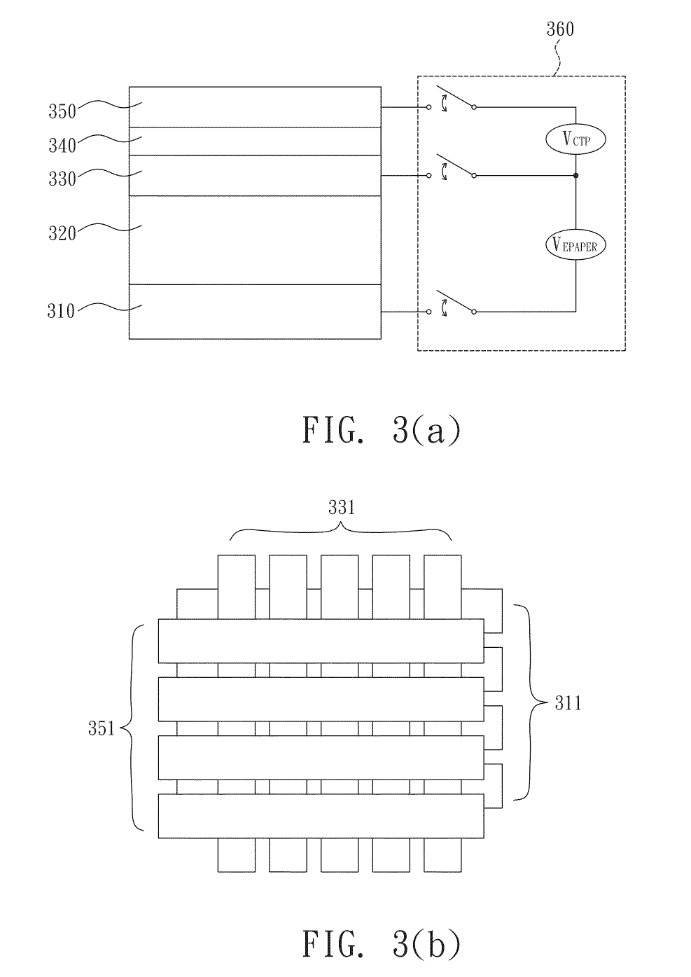

Please refer to FIG. 3(a)-3(b), which illustrate an electronic paper touch apparatus according to another preferred embodiment of the present invention. As illustrated in FIG. 3(a), the electronic paper touch apparatus has a first electrode layer 310, an electronic paper display layer 320, a first transparent electrode layer 330, a transparent dielectric layer 340, a second transparent electrode layer 350, and a control unit 360.

As illustrated in FIG. 3(b), the first electrode layer 310 has multiple first strip electrodes 311 extending along a first direction.

The electronic paper display layer 320, located above the first electrode layer 310, can be a display layer having multiple micro capsules, a display layer having multiple micro cups, or a display layer having multiple rotatable balls.

The first transparent electrode layer 330, for example but not limited to a transparent ITO layer, is located above the electronic paper display layer 320 and has multiple first transparent strip electrodes 331 extending along a second direction, the second direction being perpendicular or skew to the first direction.

The transparent dielectric layer 340 is a transparent insulation layer located above the first transparent electrode layer 330.

The second transparent electrode layer 350, for example but not limited to a transparent ITO layer, is located above the transparent dielectric layer 340 and has multiple second transparent strip electrodes 351 extending along a third direction, the third direction being perpendicular or skew to the second direction.

The control unit 360 has a touch mode and an electronic paper mode, wherein, when in the touch mode, the control unit 360 will have a touch voltage source V_{CTP} coupled between the first transparent electrode layer 330 and the second transparent electrode layer 350 to execute a capacitive touch detection procedure, so as to detect a touch operation; when in the electronic paper mode, the control unit 360 will have an electronic paper voltage source V_{EPAPER} coupled between the first electrode layer 310 and the first transparent electrode layer 330 to execute an electronic paper image update procedure, so as to provide a display.

The touch voltage source V_{CTP} has a first voltage and the electronic paper voltage source V_{EPAPER} has a second voltage. Preferably, the first voltage is not higher than the second voltage.

Preferably, the first electrode layer 330 is located above a substrate (not shown in the figure).

Preferably, the electronic paper touch apparatus further includes a protective glass layer (not shown in the figure) covering the second transparent electrode layer 350.

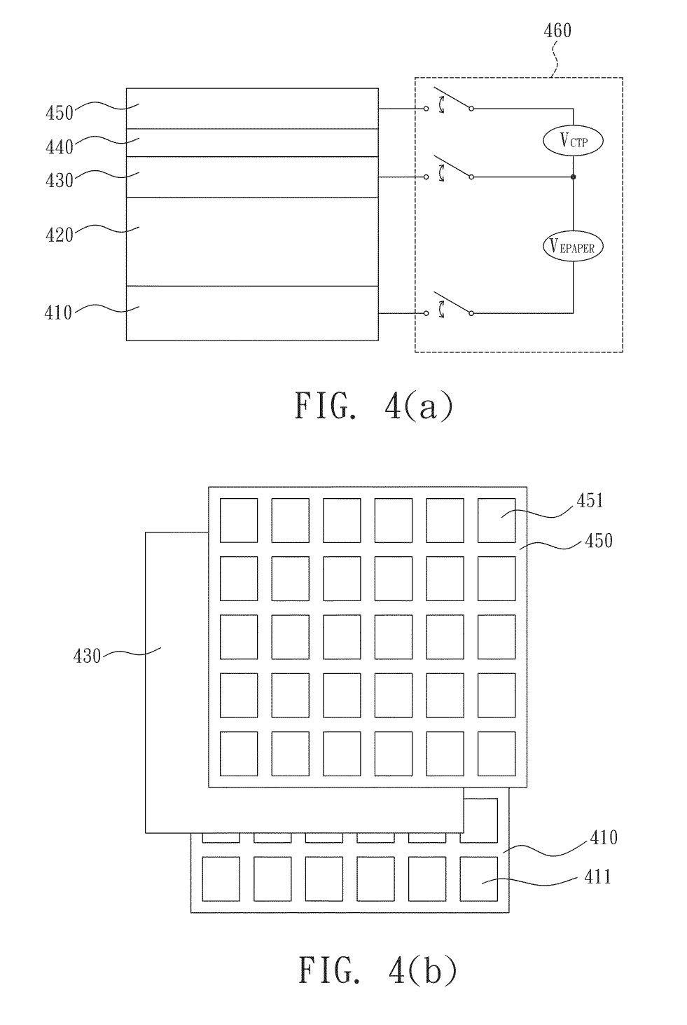

Please refer to FIG. 4(a)-4(b), which illustrates an electronic paper touch apparatus according to still another preferred embodiment of the present invention. As illustrated in FIG. 4(a), the electronic paper touch apparatus has a first electrode layer 410, an electronic paper display layer 420, a first transparent electrode layer 430, a transparent dielectric layer 440, a second transparent electrode layer 450, and a control unit 460.

As illustrated in FIG. 4(b), the first electrode layer 410 has multiple electrodes 411.

The electronic paper display layer 420, located above the first electrode layer 410, can be a display layer having multiple micro capsules, a display layer having multiple micro cups, or a display layer having multiple rotatable balls.

The first transparent electrode layer 430, for example but not limited to a transparent ITO layer, is a planar transparent electrode located above the electronic paper display layer 420.

The transparent dielectric layer 440 is a transparent insulation layer located above the first transparent electrode layer 430.

The second transparent electrode layer 450, for example but not limited to a transparent ITO layer, is located above the transparent dielectric layer 440 and has multiple transparent electrodes 451.

The control unit 460 has a touch mode and an electronic paper mode, wherein, when in the touch mode, the control unit 460 will have a touch voltage source V_{CTP} coupled between the first transparent electrode layer 430 and the second transparent electrode layer 450 to execute a capacitive touch detection procedure, so as to detect a touch operation; when in the electronic paper mode, the control unit 460 will have an electronic paper voltage source V_{EPAPER} coupled between the first electrode layer 410 and the first transparent electrode layer 430 to execute an electronic paper image update procedure, so as to provide a display.

The touch voltage source V_{CTP} has a first voltage and the electronic paper voltage source V_{EPAPER} has a second voltage. Preferably, the first voltage is not higher than the second voltage.

Preferably, the first electrode layer 430 is located above a substrate (not shown in the figure).

Preferably, the electronic paper touch apparatus further includes a protective glass layer (not shown in the figure) covering the second transparent electrode layer 450.

Thanks to the novel design mentioned above, the present invention possesses the following advantages:

1. The electronic paper touch apparatus of the present invention can make use of a bi-stable display characteristic of electronic paper to provide display function and touch function simultaneously.

2. The electronic paper touch apparatus of the present invention can utilize an electrode layer of an electronic paper device to execute an electronic paper image update procedure or a capacitive touch detection procedure.

3. The electronic paper touch apparatus of the present invention can utilize two electrode layers of an electronic paper device to execute an electronic paper image update procedure or a capacitive touch detection procedure.

4. The electronic paper touch apparatus of the present invention can offer two capacitive touch planes on two opposite sides of an electronic paper device.

5. The electronic paper touch apparatus of the present invention can alter a static touch figure in response to a touch input to facilitate a user in performing a touch operation.

In conclusion, the present invention multiplexes an electronic paper structure to execute an electronic paper image update procedure or a capacitive touch detection procedure. In addition, the present invention offers two capacitive touch planes on two opposite sides of an electronic paper device, and makes use of the bi-stable characteristic of electronic paper to provide a static touch figure to facilitate a user in performing a touch operation. As a result, the present invention has made a break-through in touch apparatuses.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. An electronic paper touch apparatus, comprising:
a first electrode layer, having multiple strip electrodes extending along a first direction;
an electronic paper display layer, located above said first electrode layer;
a transparent electrode layer, located above said electronic paper display layer and having multiple transparent strip electrodes extending along a second direction, said second direction being perpendicular or skew to said first direction; and
a control unit, having a touch mode and an electronic paper mode, wherein when in said touch mode, said control unit will have a touch voltage source coupled between said first electrode layer and said transparent electrode layer to execute a capacitive touch detection procedure; when in said electronic paper mode, said control unit will have an electronic paper voltage source coupled between said first electrode layer and said transparent electrode layer to execute an electronic paper image update procedure.

2. The electronic paper touch apparatus as disclosed in claim 1, wherein said electronic paper display layer includes multiple micro capsules, multiple micro cups, or multiple rotatable balls.

3. The electronic paper touch apparatus as disclosed in claim 1, wherein said touch voltage source has a first voltage, said electronic paper voltage source has a second voltage, and said first voltage is not higher than said second voltage.

4. The electronic paper touch apparatus as disclosed in claim 1, wherein said capacitive touch detection procedure includes a charging step, a charge redistribution step, and a comparison step.

5. The electronic paper touch apparatus as disclosed in claim 4, wherein said capacitive touch detection procedure further includes a reverse bias step.

6. The electronic paper touch apparatus as disclosed in claim 1, wherein said the first electrode layer includes a transparent material.

7. The electronic paper touch apparatus as disclosed in claim 1, further comprising a protective glass layer covering said transparent electrode layer.

8. An electronic paper touch apparatus, comprising:
a first electrode layer, having multiple electrodes;
an electronic paper display layer, located above said first electrode layer;
a transparent electrode layer, located above said electronic paper display layer and being a planar transparent electrode; and
a control unit, having a touch mode and an electronic paper mode, wherein when in said touch mode, said control unit will output multiple touch voltages to multiple corners of said transparent electrode to execute a capacitive touch detection procedure; when in said electronic paper mode, said control unit will have an electronic paper voltage source coupled between said first electrode layer and said transparent electrode layer to execute an electronic paper image update procedure.

9. The electronic paper touch apparatus as disclosed in claim 8, wherein said electronic paper display layer includes multiple micro capsules, multiple micro cups, or multiple rotatable balls.

10. The electronic paper touch apparatus as disclosed in claim 8, wherein said multiple touch voltages are not higher than a voltage of said electronic paper voltage source.

11. The electronic paper touch apparatus as disclosed in claim 8, wherein said first electrode layer is located above a substrate.

12. The electronic paper touch apparatus as disclosed in claim 8, further comprising a protective glass layer covering said transparent electrode layer.

13. An electronic paper touch apparatus, comprising:
a first electrode layer;
an electronic paper display layer, located above said first electrode layer;
a first transparent electrode layer, located above said electronic paper display layer;
a transparent dielectric layer, located above said first transparent electrode layer;
a second transparent electrode layer, located above said transparent dielectric layer; and
a control unit, having a touch mode and an electronic paper mode, wherein when in said touch mode, said control unit will have a touch voltage source coupled between said first transparent electrode layer and said second transparent electrode layer to execute a capacitive touch detection procedure; when in said electronic paper mode, said control unit will have an electronic paper voltage source coupled between said first electrode layer and said first transparent electrode layer to execute an electronic paper image update procedure.

14. The electronic paper touch apparatus as disclosed in claim 13, wherein said electronic paper display layer includes multiple micro capsules, multiple micro cups, or multiple rotatable balls.

15. The electronic paper touch apparatus as disclosed in claim 13, wherein said touch voltage source has a first voltage, said electronic paper voltage source has a second voltage, and said first voltage is not higher than said second voltage.

16. The electronic paper touch apparatus as disclosed in claim 13, wherein said first electrode layer is located above a substrate.

17. The electronic paper touch apparatus as disclosed in claim 13, further comprising a protective glass layer covering said second transparent electrode layer.

18. The electronic paper touch apparatus as disclosed in claim 13, wherein said first electrode layer includes multiple first strip electrodes extending along a first direction; said first transparent electrode layer includes multiple first transparent strip electrodes extending along a second direction, said second direction being perpendicular or skew to said first direction; and said second transparent electrode layer includes multiple second transparent strip electrodes extending along a third direction, said third direction being perpendicular or skew to said second direction.

19. The electronic paper touch apparatus as disclosed in claim 13, wherein said first electrode layer includes multiple electrodes; said first transparent electrode layer is a planar transparent electrode; and said second transparent electrode layer includes multiple transparent electrodes.
